(19) United States
(12) Patent Application Publication
(10) Pub. No.: US 2005/0061580 A1
(43) Pub. Date: Mar. 24, 2005

(54) Flow altering valve for vehicular exhaust system

(76) Inventors: Dirk Wiemeler, Edenkoben (DE); Rico Weinert, Gommersheim (DE); Alexander Schinko, Mannheim (DE); Richard Veneziano, Jackson, MI (US); Pavel Robles, Jackson, MI (US); George Labarge, Tecumseh, MI (US)

Correspondence Address: HARNESS, DICKEY & PIERCE, P.L.C., P.O. BOX 828, BLOOMFIELD HILLS, MI, 48303, US

(21) Appl. No.: 10/984,709

(22) Filed: Nov. 9, 2004

Related U.S. Application Data
(63) Continuation of application No. 10/677,554, filed on Oct. 2, 2003.

(30) Foreign Application Priority Data
Mar. 14, 2003 (DE) 10311201.4

(51) Int. Cl. F01N 1/00; F16K 17/00

(52) U.S. Cl. 181/254; 181/237

(57) ABSTRACT

A valve adaptable for use in altering fluid flow in an exhaust system of a vehicle has a movable member including a valve disk and an assembly element enabling the valve to be mounted to the exhaust system with the disk located substantially parallel to and facing an open end of a preselected exhaust system conduit. The disk is movable along an axis of the open end to vary fluid flow at the open end.

### CROSS-REFERENCE TO RELATED APPLICATIONS

This application is a continuation of U.S. patent application Ser. No. 10/677,554, filed Oct. 2, 2003.

### BACKGROUND OF THE INVENTION

The invention relates to flow altering valves for exhaust systems of motor vehicles.

Mufflers with variable damping characteristic are disclosed in U.S. Pat. No. 4,484,659; U.S. Pat. No. 5,614,669 or also U.S. 2002/0033303 A. All of these mufflers have a housing into which the exhaust gases of an internal combustion engine are passed by way of an inlet pipe and passed out by way of an outlet pipe. In the interior of the muffler housing, additional pipes are provided.

Further, in the interior of the muffler housing a valve is provided. This has a spring-loaded closure element, which in rest condition, i.e., at low gas flow rate, for example when the engine is idling, closes a gas port. This compels the exhaust gases to traverse a long distance, sharply damping noise interference, inside the muffler housing.

If the rotational speed of the internal combustion engine is increased, the flow of exhaust gas increases. Hence, a higher pressure acts on the closing element of the valve, so that it opens against the action of the spring. The exhaust gases flow through the opening, now clear, the pressure drop in the muffler housing recedes, and the engine power is increased.

U.S. Pat. No. 4,484,659 discloses several valve designs.

A first design employs a valve disk of spring steel, attached on one side.

A second design employs a valve disk attached to a tension spring.

The third design employs a swing flap attached by a membrane chamber whose control pressure is generated by a Venturi nozzle.

The fourth design employs a rotary slide moved by way of a membrane chamber whose control pressure is generated by a Venturi nozzle.

U.S. 2002/033303 A, as closure element, employs a flap, which is spring loaded.

U.S. Pat. No. 5,614,699 likewise employs a spring-loaded swing flap.

Since in all these designs the valve is accommodated in the interior of the muffler housing, all its parts are exposed to the heat, the aggressive elements and the pressure pulsations of the exhaust gas. The several parts must therefore be made of temperature-resistant and oxidation-free material. Therefore these designs have failed to find acceptance in practice.

### SUMMARY OF THE INVENTION

A valve adaptable for use in altering fluid flow in an exhaust system has a movable member including a valve disk, and an assembly element enabling the valve to be mounted to the exhaust system in a manner such that the valve disk is located substantially parallel to and facing an open end of a preselected fluid conduit of the exhaust system, the disk being movable along an axis of the open end to vary fluid flow at the open end.

The essential advantage of the present invention is based on the fact that the valve housing in which the temperature-sensitive spring is accommodated is positioned outside of the muffler housing. The hot exhaust gases cannot directly heat the valve housing. Furthermore, the valve housing is cooled by the airstream. Since the valve housing is gastight and connected gastight to the muffler housing, no exhaust gases can escape.

### BRIEF DESCRIPTION OF THE DRAWING

With reference to the drawings, the invention will be illustrated in more detail in the form of an embodiment by way of example. In each instance quite schematically,

FIG. 1 in section, shows a portion of an acoustic damper with variable damping characteristic, only the valve portion being represented, and

FIG. 2 shows a longitudinal section of the complete acoustic damper.

### DETAILED DESCRIPTION

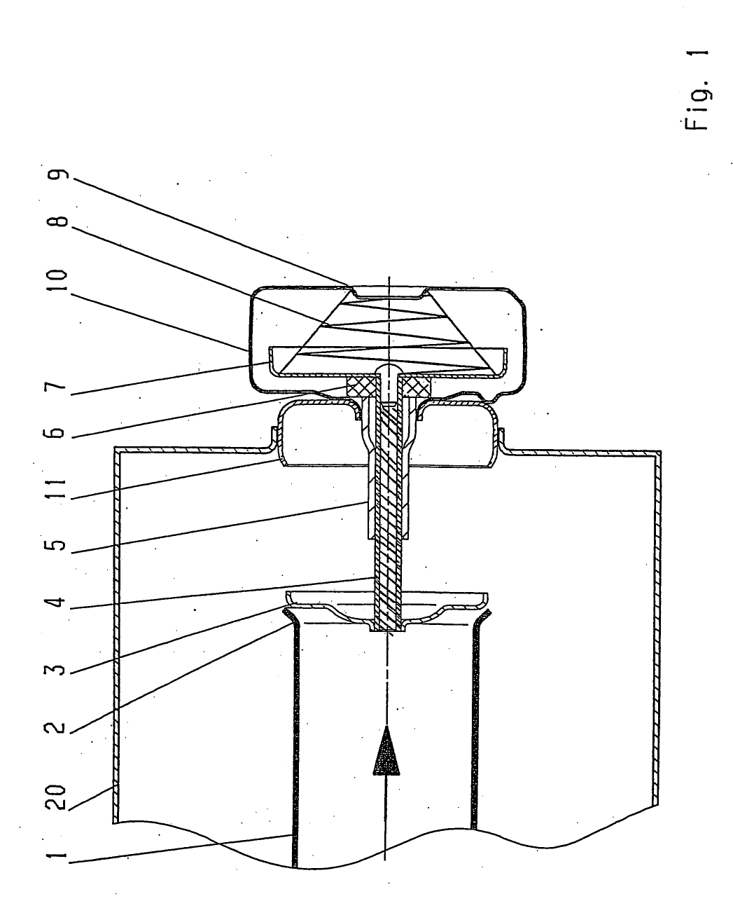

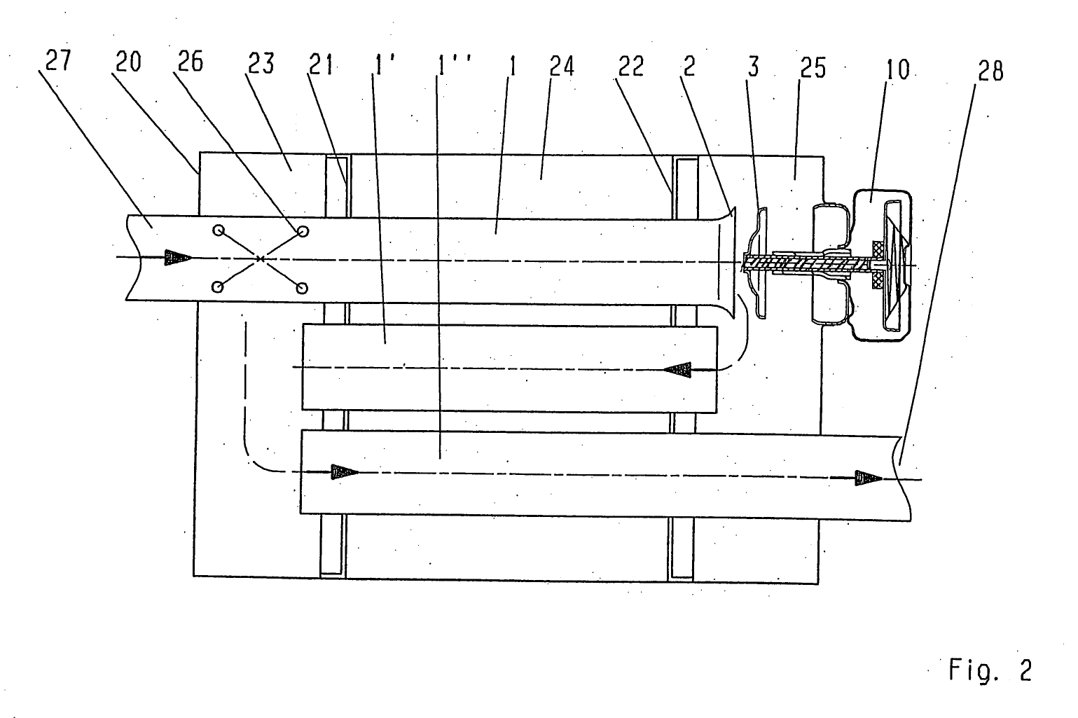

FIGS. 1 and 2, quite schematically and in section, show a muffler housing 20 whose interior is divided by transverse partitions 21, 22 into three chambers 23, 24, 25. A pipe 27 carries exhaust gases into the housing 20, and a pipe 28 carries the exhaust gases out of the housing 20 again.

In the interior of the housing 20, three pipes 1, 1′, 1″ carrying gas are seen. The pipe 1 has a perforation 26, through which the gases can escape, in the neighborhood of the first chamber 23.

As FIG. 1 shows to a large scale, the end 2 of the first gas pipe 2 conically widened. A likewise conical valve disk 3 closes the end 2 of the pipe 1. The valve disk 3 is mounted on a guide rod 4, guided in turn in a guide sleeve 5. The guide sleeve 5 is held by an assembly sleeve 11 mounted gastightly in the wall of the acoustic damper housing 20. Outside of the muffler 20, a valve housing 10 is seen. In it, there is a conical spring 8 held by a spring suspension 9. The other end of the spring 8 bears upon a spring guide disk 7 mounted at the end of the guide rod 4. In this way, the spring 8 gains a secure support and distributes its force symmetrically to the guide rod.

Between the spring guide disk 7 and the valve housing 10, a ring 6 of wire knit is placed on the guide rod 4. This ring 6 serves as damping element and prevents noise interference.

As FIG. 1 shows, the valve disk 3 in rest condition is subject to the action of the spring 8 at a short distance from the end 2 of the pipe 1. Therefore, the exhaust gases flow through this annular gap of small flow cross-section. The main quantity of the exhaust gases leaves the pipe 1 by way of the perforation 26 (FIG. 2), if present, flows through the first chamber 23 into the gas pipe 1″, and leaves the muffler housing 20 by way of the outlet pipe 28.

As soon as the rotational speed of the internal combustion engine (not shown) increases, the quantity of exhaust gas flowing in through the pipe 27 into the muffler housing 20 increases. This increases the jet impact on the valve disk 3. As soon as the pressure is high enough, the valve disk 3 opens against the force of the spring 8 and clears the way for the exhaust gases. This is shown in FIG. 2. Now the exhaust gases flow out of the pipe 1 into the third chamber 25, thence through the second gas pipe 1′ into the first chamber 23, and leave the latter by way of the pipe 1″.

The entire disclosure of German Patent Application No. 10311201.4 filed Mar. 14, 2003, is incorporated by reference.

1. A valve adaptable for use in altering fluid flow in an exhaust system of a vehicle, the valve comprising:
a movable member including a valve disk; and
an assembly element enabling the valve to be mounted to the exhaust system in a manner such that the valve disk is located substantially parallel to and facing an open end of a preselected fluid conduit of the exhaust system, the disk being movable along an axis of the open end to vary fluid flow at the open end.

2. A valve adaptable for use in altering flow in an exhaust system of a vehicle, the valve comprising:
a movable member including a valve disk; and
an assembly element enabling the valve to be mounted to the exhaust system in a manner such that the valve disk is adapted to overlap an open end of a preselected fluid conduit of the exhaust system to enable a radial component of fluid flow exiting the open end.

3. A valve for use in altering fluid in an exhaust system of a vehicle, the valve comprising:
a movable member including a valve disk and a guide rod having a first end coupled to the valve disk;
a biasing element housing coupled for receipt of a second end of the guide rod and containing a biasing element isolated from the valve disk for urging the guide rod in a predetermined direction; and
an assembly element enabling the valve to be mounted to the exhaust system in a manner such that the valve disk can at least partially alter fluid flow exiting a preselected fluid conduit of the exhaust system by moving along an axis of the preselected fluid conduit.

4. The valve of claim 3 wherein the biasing element comprises a spring.

5. The valve of claim 4 further comprising a spring guide coupled to the second end of the guide rod and shaped for receipt of one end of the spring.

6. The valve of claim 3 further comprising a guide sleeve at least partially surrounding the guide rod and having a first end coupled to the biasing element.

7. The valve of claim 3 further comprising a stop element coupled between the second end of the guide rod and the biasing element.

8. The valve of claim 7 wherein the stop element comprises a ring of knitted wire.

9. The valve of claim 4 wherein the spring is conical.

10. A vehicle exhaust system comprising:
a fluid conduit having at least one open end; and
a valve associated with the at least one open end, the valve comprising a movable member including a valve disk, and an assembly element coupling the valve to the fluid conduit in a manner such that the valve disk is located substantially parallel to and facing the at least one open end, the disk being movable along an axis of the open end to vary fluid flow at the open end.

11. A vehicle exhaust system comprising:
a fluid conduit having at least one open end; and
a valve associated with the at least one open end, the valve comprising a movable member including a valve disk, and an assembly element coupling the valve to the fluid conduit such that the valve disk overlaps the at least one open end enabling a radial component of fluid flow exiting the at least one open end.

12. A vehicle exhaust system comprising:
a fluid conduit having at least one open end; and
a valve associated with the at least one open end, the valve comprising a movable member including a valve disk and a solid guide rod having a first end coupled to the valve disk, a biasing element housing coupled for receipt of a second end of the guide rod and containing a biasing element isolated from the valve disk for urging the guide rod in a predetermined direction, and an assembly element for enabling the valve disk to be positioned parallel to the at least one open end in a manner such that the valve disk can move to vary an amount of radial fluid flow at the at least one open end.

13. The vehicle exhaust system of claim 12 wherein the biasing element comprises a spring.

14. The vehicle exhaust system of claim 13 further comprising a spring guide coupled to the second end of the guide rod and shaped for receipt of one end of the spring.

15. The vehicle exhaust system of claim 12 further comprising a guide sleeve at least partially surrounding the guide rod and having a first end coupled to the biasing element.

16. The vehicle exhaust system of claim 12 further comprising a stop element coupled between the second end of the guide rod and the biasing element.

17. The vehicle exhaust system of claim 12 wherein the stop element comprises a ring of knitted wire.

18. The vehicle exhaust system of claim 13 wherein the spring is conical.

19. The vehicle exhaust system of claim 12 wherein the valve disk moves against a force of the biasing element when subjected to a predetermined exhaust gas pressure in the fluid conduit.
